(19) United States
(12) Patent Application Publication
(10) Pub. No.: US 2026/0121906 A1
(43) Pub. Date: Apr. 30, 2026

(54) PREDICTIVE FAULT DETECTION AND RESOLUTION SYSTEM FOR SERVICE PROVIDER NETWORKS

(71) Applicant: Network Innovations, LLC, Chicago, IL (US)

(72) Inventors: Fleming Shi, Scotts Valley, CA (US); Thomas Gamet, Orlando, FL (US)

(21) Appl. No.: 19/369,162

(22) Filed: Oct. 24, 2025

Related U.S. Application Data
(60) Provisional application No. 63/712,025, filed on Oct. 25, 2024.

(51) Int. Cl. H04L 41/0654; H04L 41/16

(52) U.S. Cl. CPC H04L 41/0654; H04L 41/16

(57) ABSTRACT

The present disclosure provides a system for predictive fault detection and resolution in a service provider network. The system includes a telemetry collection module configured to collect real-time or near real-time telemetry data from network devices, a data processing engine configured to process the collected telemetry data, and a historical fault dataset configured to store previously recorded faults and associated network event logs. A GenAI agent is configured to analyze network events using chain-of-thought reasoning and assign labels to the network events based on the processed telemetry data and historical fault dataset. A time-series machine learning model determines potential faults based on temporal patterns in network behavior identified from the labeled network events. An action resolution engine generates automatic resolutions for the determined potential faults or escalates the potential faults with recommended actions.

### CROSS-REFERENCE TO RELATED APPLICATIONS

This application claims priority to U.S. Application No. 63/712,025, titled “SYSTEM AND METHOD FOR ADVANCED PREDICTIVE FAULT DETECTION AND AUTONOMOUS RESOLUTION SYSTEM USING TIME-SERIES MACHINE LEARNING MODELS AND GENAI AGENTS WITH LLM AND RAG FOR NETWORK SERVICE PROVIDERS”, filed Oct. 25, 2024, which is hereby incorporated by reference in its entirety.

### BACKGROUND

In large-scale service provider networks, enterprise-level customers rely on consistent uptime and high-quality service for their critical operations. These networks encompass a complex array of components including routers, gateways, firewalls, and software-defined wide area network (SD-WAN) solutions, each representing a potential point of failure. As network infrastructures grow in complexity and scale, the challenge of maintaining optimal performance and minimizing disruptions becomes increasingly demanding.

Traditional fault detection and management systems often employ static rule-based approaches or depend heavily on human intervention. However, these methods are becoming less effective in addressing the evolving nature of modern network environments. The dynamic and interconnected nature of contemporary networks requires more sophisticated approaches to fault prediction, detection, and resolution.

Moreover, the rapid pace of technological advancement in networking introduces new fault patterns and potential issues that may not be readily apparent or easily diagnosed using conventional methods. This can result in service interruptions, degraded performance, and customer dissatisfaction, which in turn may lead to increased operational costs and potential loss of business for service providers.

Improvements are needed.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The present disclosure includes an advanced system that monitors computer networks to prevent problems before they happen. It continuously collects and analyzes data from network devices using artificial intelligence and machine learning technology. The system can identify patterns that might indicate future network issues by examining both current and historical information. When it detects a potential problem, the system can either automatically implement solutions or alert human operators with specific recommendations. By predicting and addressing network issues proactively, the system helps service providers maintain reliable connections and minimize disruptions for their enterprise customers. The technology continuously improves its prediction accuracy through feedback from resolved issues, becoming more effective over time.

These and other features and advantages are described in greater detail below.

### BRIEF DESCRIPTION OF THE DRAWINGS

The accompanying drawings, which are incorporated in and constitute a part of this specification, show embodiments and together with the description, serve to explain the principles of the methods and systems: Some features are shown by way of example, and not by limitation, in the accompanying drawings. In the drawings, like numerals reference similar elements.

FIG. 1 illustrates a block diagram of a predictive fault detection and resolution system according to the present disclosure.

FIG. 2 illustrates a block diagram of a GenAI Agent according to the present disclosure.

FIG. 3 illustrates a system diagram showing data flow and interaction between components according to the present disclosure.

FIG. 4 illustrates a flowchart for an advanced predictive fault detection and autonomous resolution system according to the present disclosure.

FIG. 5 illustrates a flowchart of a method for fault detection and resolution in a network system according to the present disclosure.

The accompanying drawings show examples of the disclosure. It is to be understood that the examples shown in the drawings and/or discussed herein are non-exclusive and that there are other examples of how the disclosure may be practiced.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to an advanced predictive fault detection and resolution system designed for service providers serving enterprise customers. This system may utilize cutting-edge technology to anticipate and address network faults before they impact service quality or cause disruptions.

The system may employ machine learning models, with a focus on time-series processing, to analyze temporal patterns in network device behavior. By examining real-time telemetry data and historical fault patterns, the system may predict potential issues and take proactive measures to resolve them.

The system may incorporate artificial intelligence agents equipped with advanced reasoning capabilities. These agents may analyze past cases and ticket histories to classify and label network events, enhancing the system's ability to understand and predict faults in context.

The system may be capable of autonomous fault resolution when certain conditions are met. When automated resolution is not possible, the system may escalate issues to human operators, providing suggested actions based on its analysis.

A feature of the system may be its ability to continuously learn and improve. As new data is processed and outcomes are observed, the system may refine its predictive models and enhance its understanding of network behavior.

The system may be designed to operate at scale, capable of handling large, complex service provider networks. These networks may span multiple technologies and geographical regions, requiring a robust and flexible approach to fault detection and resolution.

By leveraging advanced predictive capabilities and autonomous resolution features, the system may help service providers maintain high levels of network performance and reliability. This approach may lead to improved service quality for enterprise customers and potentially reduce operational costs for service providers.

In large-scale service provider networks serving enterprise-level customers, consistent uptime and high-quality service are factors for maintaining customer satisfaction and meeting service level agreements. These networks typically comprise various components such as routers, gateways, firewalls, and software-defined wide area network (SD-WAN) solutions, each of which may be a potential point of failure.

Current fault detection and management systems often rely on static rule-based approaches or human intervention. However, these methods may be insufficient to handle the growing complexity of modern network environments. As networks evolve and new technologies emerge, fault patterns may change, making it challenging for traditional systems to adapt and predict problems effectively.

The limitations of existing fault management approaches may lead to several challenges for service providers. Service interruptions and degraded performance may occur more frequently, potentially resulting in dissatisfied customers. This, in turn, may increase customer churn rates and operational costs for service providers as they struggle to maintain network reliability and quickly resolve issues.

Furthermore, the dynamic nature of modern networks requires more sophisticated fault management approaches. Static systems may struggle to keep pace with the rapid changes in network technologies and configurations. This gap between traditional fault detection methods and the evolving complexity of networks highlights the need for more adaptive and predictive solutions in network fault management.

To address the challenges in fault detection and management for large-scale service provider networks, a new approach is proposed that contemplates systems and methods to support an advanced fault prediction and resolution system. This system may be specifically designed for service providers serving enterprise customers.

The system may utilize machine learning models, with an emphasis on time-series processing, to predict network faults by identifying temporal patterns in network device behavior. The system may leverage real-time telemetry data and historical fault patterns, combined with advanced artificial intelligence agents and machine learning models, to offer a solution that continuously improves its fault prediction capabilities while reducing reliance on human operators.

The system may include a telemetry collection module deployed across the network infrastructure to gather real-time data from various network devices. This collected data may be processed by a real-time data processing engine, which may integrate the incoming telemetry streams with historical data stored in the system.

The system may incorporate artificial intelligence (AI) agents, including generative AI (GenAI) agents, equipped with chain-of-thought reasoning capabilities. These agents may automatically label and classify faults based on a contextual analysis of past cases and ticket histories. By examining both historical fault data and real-time telemetry from network devices, these agents may help refine the system's predictions by improving the labeling and contextual understanding of network events. This dynamic labeling process may ensure that the system not only recognizes known faults but also adapts to emerging patterns, potentially making the machine learning models more accurate over time.

The predictive system, coupled with real-time data from network monitoring tools, may autonomously resolve issues when predefined conditions are met, or escalate them to human operators with suggested resolutions. The system may continuously evolve, potentially ensuring it remains effective as network conditions change and new technologies are introduced.

The system may be implemented as a non-transitory computer-readable medium storing instructions that, when executed by a processor, cause the processor to perform operations for predictive fault detection and resolution in a service provider network. These operations may include receiving and processing real-time telemetry data, analyzing the processed data using artificial intelligence agents, determining potential faults using time-series machine learning models, and initiating automatic resolutions or escalating issues as needed.

The system may also include a management console where human operators can view network statuses, predictions, and resolutions. The management console may allow human operators to interface with the system. The management console may provide a centralized location for monitoring and managing the network's health and performance.

By leveraging advanced predictive capabilities and autonomous resolution features, the system may help service providers maintain high levels of network performance and reliability. This approach may lead to improved service quality for enterprise customers and potentially reduce operational costs for service providers.

The system for predictive fault detection and resolution in service provider networks may offer several differentiating features that set it apart from traditional fault management approaches.

The system may provide proactive fault prediction capabilities. By analyzing temporal patterns in network device behavior, the system may anticipate potential issues before they affect network performance. This proactive approach may help reduce downtime and enhance overall service quality for enterprise customers.

The system may incorporate adaptive learning through artificial intelligence agents. These agents may utilize chain-of-thought reasoning to analyze fault histories and continuously update the machine learning (ML) models with accurate and context-rich labels. This ongoing learning process may improve the system's ability to predict new or previously unclassified faults, potentially enhancing its effectiveness over time.

The system may be designed to scale across large, complex service provider networks. The scalability of the system may allow it to handle networks that span multiple technologies and geographical regions, making it suitable for diverse and expansive network environments.

The automation capabilities of the system may contribute to reduced operational costs for service providers. By automating much of the fault resolution process, the system may decrease the need for human intervention in routine fault management tasks. This automation may lead to improved efficiency in network operations and potentially lower overall operational expenses.

The system's ability to reduce downtime and prevent network failures may enhance service level agreement (SLA) compliance. By maintaining higher levels of network reliability and performance, service providers may be better positioned to meet or exceed their SLAs. This improved compliance may contribute to higher customer satisfaction among enterprise clients.

The system may include a telemetry collection module configured to gather real-time or near real-time telemetry data from network devices. The telemetry collection module may be deployed across the network infrastructure to collect data from various components such as routers, switches, gateways, and other network devices. This module may utilize protocols such as Simple Network Management Protocol (SNMP), Network Configuration Protocol (NETCONF), or Google Remote Procedure Call (gRPC) to retrieve performance metrics, error logs, and configuration data from the network devices.

The system may also comprise a historical fault dataset designed to store previously recorded faults and associated network event logs. This dataset may serve as a repository of past network issues, their resolutions, and the context in which they occurred. The historical fault dataset may be structured to allow efficient querying and analysis, potentially using a combination of relational and Not Only Structured Query Language (NoSQL) database technologies to handle structured and unstructured data.

A data processing engine may be included in the system to process the collected telemetry data. This engine may be responsible for cleaning, normalizing, and aggregating the raw data collected by the telemetry collection module. The data processing engine may perform tasks such as time series alignment, feature extraction, and data transformation to prepare the telemetry data for analysis by other system components.

The system may incorporate Generative Artificial Intelligence (GenAI) agents configured to analyze network events using chain-of-thought reasoning and assign labels to the network events based on the processed telemetry data and the historical fault dataset. These agents may employ natural language processing and machine learning techniques to understand the context of network events and classify them into relevant categories. The chain-of-thought reasoning capability may allow the agents to explain their decision-making process, potentially improving the interpretability of their classifications.

The system may include time-series machine learning models configured to determine potential faults based on temporal patterns in network behavior identified from the labeled network events. These models may use techniques such as recurrent neural networks, long short-term memory networks, or transformer architectures to capture complex temporal dependencies in network behavior. The time-series models may be trained on historical data and continuously updated to improve their predictive accuracy.

An action resolution engine may be part of the system, configured to generate automatic resolutions for the determined potential faults or to escalate the potential faults with recommended actions. This engine may contain a knowledge base of predefined resolution strategies for common network issues. When a potential fault is identified, the action resolution engine may evaluate the severity and context of the issue to determine whether automatic resolution is appropriate or if human intervention is required.

The system may further comprise an adaptive learning module configured to update the time-series machine learning model based on feedback from the GenAI agents and resolutions generated by the action resolution engine. This module may analyze the outcomes of fault resolutions, both automatic and manual, to refine the predictive models and improve their accuracy over time. The adaptive learning module may employ techniques such as reinforcement learning or online learning to continuously adapt to changing network conditions and emerging fault patterns.

A management console may be included in the system, configured to display network status information, predicted faults, and recommended actions to human operators when the action resolution engine escalates potential faults. This console may provide a user-friendly interface for network administrators to monitor the health of the network, review AI-generated insights, and take action on escalated issues. The management console may include features such as customizable dashboards, real-time alerts, and detailed fault analysis reports to support efficient network management.

The system may operate through a series of interconnected processes to detect and resolve potential faults in a service provider network. The operation may begin with telemetry collection, where real-time or near real-time data is gathered from various network devices (routers, SD-WAN gateways, etc.) across the infrastructure and passed to data processing engine.

The collected telemetry data may then undergo processing and analysis. During this phase, the system may compare the incoming data with historical fault information stored in a database. This comparison may help identify patterns or anomalies that could indicate potential network issues.

Artificial intelligence agents may be employed to analyze and label the processed telemetry data. These agents may utilize chain-of-thought reasoning to examine case histories and ticket logs, determining classifications and labels for network events. The use of chain-of-thought reasoning may allow the agents to refine their contextual understanding of network events over time, potentially improving the accuracy and relevance of their classifications.

The labeled data may then be used by time-series machine learning models to predict potential faults. These models may analyze temporal patterns in network behavior to identify issues before they impact network performance.

When a potential fault is predicted, the system may initiate a resolution process. The system may use the action resolution engine to resolve potential faults. The system may be configured to automatically resolve determined potential faults when predefined resolution conditions are met. This automatic resolution capability may help reduce the need for human intervention in routine fault management tasks.

For situations where automatic resolution is not possible or advisable, the system may escalate the issue to human operators. In these cases, the system may provide recommended actions based on its analysis of the fault and historical resolution data.

The system may incorporate a feedback loop to continuously improve its performance. As faults are resolved, either automatically or through human intervention, the outcomes may be used to enhance the system's capabilities. An adaptive learning module may update the time-series machine learning models based on the results of fault resolutions.

Furthermore, the adaptive learning module may be configured to enhance the reasoning and labeling capabilities of the artificial intelligence agents. By analyzing the outcomes of resolved faults, the module may refine the agents'ability to classify and contextualize network events, potentially leading to more accurate fault predictions and resolutions over time.

This continuous learning process may allow the system to adapt to changing network conditions, emerging fault patterns, and new technologies. As the system processes more data and resolves more faults, its predictive accuracy and resolution capabilities may improve, potentially leading to more efficient and effective network management for service providers.

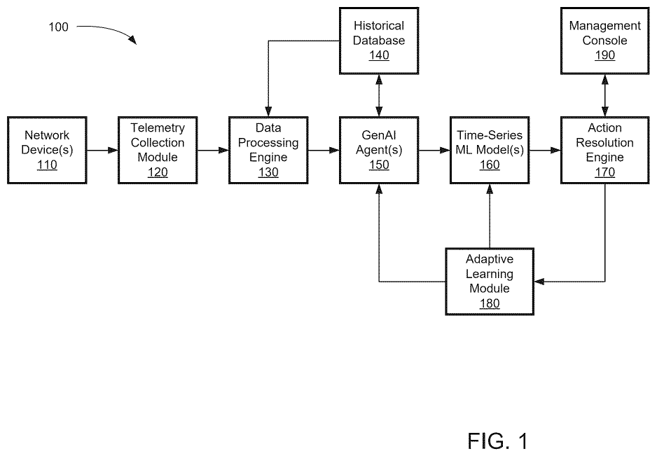

FIG. 1 illustrates a block diagram of a system 100 for predictive fault detection and resolution. The system 100 may include one or more network device(s) 110. These network device(s) 110 may be components of the service provider network, such as routers, switches, gateways, or other networking equipment.

A telemetry collection module 120 may be connected to the network device(s) 110. The telemetry collection module 120 may be configured to gather real-time or near real-time telemetry data from the network device(s) 110. This telemetry data may include performance metrics, error logs, configuration data, and other relevant information about the state and behavior of the network device(s) 110.

The telemetry collection module 120 may be connected to a data processing engine 130. The data processing engine 130 may be responsible for processing the collected telemetry data. This processing may involve tasks such as data cleaning, normalization, aggregation, and feature extraction to prepare the telemetry data for further analysis.

The system 100 may include a historical database 140. The historical database 140 may store previously recorded faults, network event logs, and other historical data relevant to the network's operation and past issues. The historical database 140 may be connected to the data processing engine 130 and may provide historical context for current network events.

One or more GenAI agent(s) 150 may be included in the system 100. The one or more GenAI agent(s) 150 may be connected to both the data processing engine 130 and the historical database 140. The one or more GenAI agent(s) 150 may be configured to analyze network events using chain-of-thought reasoning and assign labels to these events based on the processed telemetry data and historical information from the historical database 140.

The system 100 may also incorporate one or more time-series ML model(s) 160. The one or more time-series ML model(s) 160 may be connected to the one or more GenAI agent(s) 150 and may be configured to determine potential faults based on temporal patterns in network behavior identified from the labeled network events provided by the one or more GenAI agent(s) 150.

An action resolution engine 170 may be included in the system 100, connected to the one or more time-series ML model(s) 160. The action resolution engine 170 may be responsible for generating automatic resolutions for the potential faults determined by the one or more time-series ML model(s) 160 or escalating these potential faults with recommended actions when automatic resolution is not possible.

The system 100 may include an adaptive learning module 180. The adaptive learning module 180 may be connected to both the one or more GenAI agent(s) 150 and the one or more time-series ML model(s) 160. The adaptive learning module 180 may be configured to update the one or more time-series ML model(s) 160 and enhance the reasoning capabilities of the one or more GenAI agent(s) 150 based on feedback from resolved faults and ongoing network operations. The one or more GenAI agent(s) 150 may cause datasets associated with feedback from the adaptive learning module 180 to be stored in the historical database 140.

A management console 190 may be included in the system 100, connected to the action resolution engine 170. The management console 190 may provide a user interface for human operators to view network status information, predicted faults, and recommended actions when the action resolution engine 170 escalates potential faults that require human intervention.

The components of the system 100 may work together to provide a comprehensive solution for predictive fault detection and resolution in service provider networks. The flow of data and information between these components may enable the system 100 to continuously monitor network health, predict potential issues, and take appropriate actions to maintain network performance and reliability.

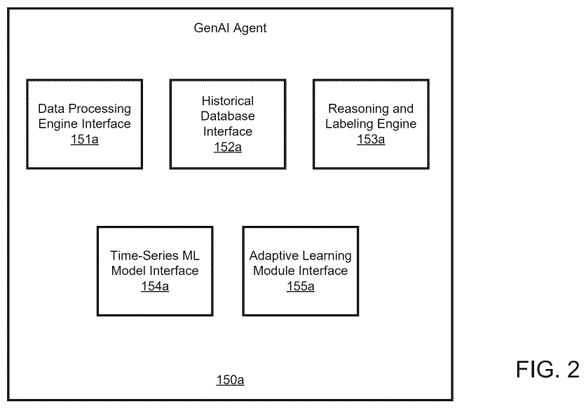

FIG. 2 illustrates a block diagram of a GenAI agent 150a of the one or more GenAI agent(s) 150, showcasing its various components and interfaces to facilitate advanced analysis and labeling of network events. The GenAI agent 150a may comprise multiple interfaces that enable communication and data exchange with other components of the system 100. These interfaces may include a data processing engine interface 151a, a historical database interface 152a, a time-series ML model interface 154a, and an adaptive learning module interface 155a.

The data processing engine interface 151a may be included in the GenAI agent 150a to facilitate communication with the data processing engine 130. The data processing engine interface 151a may allow the GenAI agent 150a to receive processed telemetry data from the data processing engine 130, enabling the agent to analyze current network events and behaviors.

The GenAI agent 150a may also include the historical database interface 152a. The historical database interface 152a may enable the GenAI agent 150a to access and retrieve historical fault data and network event logs stored in the historical database 140. By accessing this historical information, the GenAI agent 150a may gain context for current network events and improve its analysis capabilities.

The GenAI agent 150a may incorporate a reasoning and labeling engine 153a. The reasoning and labeling engine 153a may be responsible for analyzing network events using chain-of-thought reasoning techniques. The reasoning and labeling engine 153a may process the data received through the data processing engine interface 151a and the historical database interface 152a to classify and label network events.

The GenAI agent 150a may also include the time-series ML model interface 154a. The time-series ML model interface 154a may allow the GenAI agent 150a to communicate with the one or more time-series ML model(s) 160. The time-series ML model interface 154a may be used to send labeled network events to the one or more time-series ML model(s) 160 for further analysis and fault prediction.

The adaptive learning module interface 155a may be incorporated into the GenAI agent 150a. The adaptive learning module interface 155a may facilitate communication between the GenAI agent 150a and the adaptive learning module 180. Through the adaptive learning module interface 155a, the GenAI agent 150 may receive updates and refinements to its reasoning and labeling capabilities based on feedback from resolved faults and ongoing network operations.

The components within the GenAI agent 150a may work together to analyze network events, assign labels, and provide context for fault prediction. The data processing engine interface 151a and historical database interface 152a may supply the reasoning and labeling engine 153a with current and historical data. The reasoning and labeling engine 153a may then process this information to generate labeled network events, which may be sent to the one or more time-series ML model(s) 160 through the time-series ML model interface 154a. The adaptive learning module interface 155a may allow the GenAI agent 150a to continuously improve its performance based on feedback received from the adaptive learning module 180.

By incorporating these various interfaces and the reasoning and labeling engine 153a, the GenAI agent 150a may serve as a useful component in the system 100′s ability to predict and resolve network faults. The structure of the GenAI agent 150a may enable it to effectively analyze complex network behaviors, leverage historical data, and adapt to changing network conditions over time.

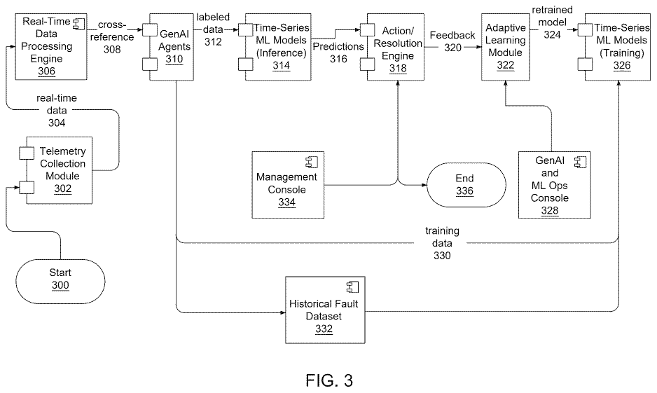

FIG. 3 depicts a system diagram showing the flow and interaction between various components in a data processing and analysis system. As shown in FIG. 3, the system may begin at a start node 300, which may represent the initial entry point for telemetry data collected from network devices. This start node 300 may serve as the origin for all data flows within the system and may contain raw, unprocessed telemetry information gathered from various network components. The start node 300 may function as a primary data repository that temporarily stores incoming network metrics, error logs, and performance indicators before they are routed to subsequent processing modules. This initial data collection point may help facilitate capture of relevant network information and access to the captured information for further analysis, establishing the foundation for the entire fault detection and resolution process.

Following the start node 300, the data may flow to a telemetry collection module 302. The telemetry collection module 302 may actively gather real-time or near real-time data from the network infrastructure, serving as the primary interface between the network devices and the fault detection system. The telemetry collection module 302 may employ various protocols such as SNMP, NETCONF, or gRPC to establish connections with network devices and extract relevant operational data. The telemetry collection module 302 may continuously monitor network components, capturing performance metrics, configuration states, and error indicators that might signal potential issues. The telemetry collection module 302 may be designed to handle high volumes of incoming data streams while maintaining low latency, facilitating capture of network information promptly for timely fault detection.

From the telemetry collection module 302, the real-time or near real-time data 304 may proceed to a data processing engine 306. The data processing engine 306 may perform preprocessing operations on the raw telemetry data, transforming it into a structured format suitable for advanced analysis. The data processing engine 306 may apply various techniques including normalization, aggregation, and feature extraction to prepare the data for subsequent processing stages. The data processing engine 306 may also perform time-series alignment to ensure temporal consistency across different data streams, enabling more accurate pattern recognition. The data processing engine 306 may filter out noise and irrelevant information while preserving signals that might indicate potential network faults. This preprocessing step may enhance the quality of the data, making it more amenable to sophisticated analysis by downstream components.

After preprocessing, a historical database may be accessed. The historical database may serve as a comprehensive repository of past network events, fault occurrences, and resolution outcomes. The historical database may maintain detailed records of previously identified issues, their symptoms, causes, and the actions taken to resolve them. The historical database may provide context for current network events, enabling the system to recognize patterns that have preceded faults in the past. The historical database may store both structured data, such as performance metrics and error codes, and unstructured data, including ticket logs and case histories. The historical database may employ efficient indexing and query mechanisms to facilitate rapid retrieval of relevant historical information when analyzing current network conditions, thereby enhancing the system's ability to accurately identify potential issues.

The processed data, enriched with historical context 308, may move to the GenAI agent(s) 310. This sophisticated component may employ advanced artificial intelligence techniques to analyze and interpret network events. The GenAI agent(s) 310 may utilize chain-of-thought reasoning to examine the relationships between different network indicators and their potential implications. The GenAI agent(s) 310 may systematically evaluate the processed telemetry data against historical patterns, applying contextual understanding to classify and label current network events. The GenAI agent(s) 310 may recognize subtle precursors to potential faults that might not be apparent through conventional analysis methods. By leveraging natural language processing capabilities, the GenAI agent(s) 310 may also extract insights from unstructured data sources such as maintenance logs and trouble tickets, further enhancing its analytical capabilities. The GenAI agent(s) 310 may continuously refine its understanding of network behavior through ongoing learning, becoming increasingly adept at identifying complex fault patterns over time. The GenAI agent(s) 310 may provide any fault data to be included in a historical fault dataset 322 used to train the time-series ML model(s) 314, 326.

From the GenAI agent(s) 312, the labeled network events 312 may proceed to the time-series ML model(s) 314, 326. This specialized machine learning component may focus on analyzing temporal patterns in network behavior to predict potential faults before they manifest as service-affecting issues. The time-series ML model(s) 314, 326 may employ advanced algorithms such as recurrent neural networks, long short-term memory networks, or transformer architectures to capture complex temporal dependencies in the data. The time-series ML model(s) 314, 326 may examine how network parameters evolve over time, identifying trends, seasonality, and anomalies that might indicate impending problems. The time-series ML model(s) 314, 326 may detect subtle deviations from normal operational patterns that often precede network failures. By analyzing the sequence and timing of events rather than just their individual characteristics, the time-series ML model(s) 314, 326 may provide a dynamic perspective on network health that complements the static analysis performed by other components. The labeled network events 312 may also be used as training data 330 for the time-series ML model(s) 314, 326.

After the time-series analysis, the predictions 316 may flow to an action resolution engine 318. This component may serve as the decision-making center of the system, determining appropriate responses to predicted faults based on their nature, severity, and potential impact. The action resolution engine 318 may contain a knowledge base of predefined resolution strategies for common network issues, enabling it to automatically address many potential problems without human intervention. For each predicted fault in the predictions 316, the action resolution engine 318 may evaluate whether automatic resolution is feasible and appropriate, considering factors such as the confidence level of the prediction, the criticality of the affected services, and the potential risks associated with automated intervention. When automatic resolution is deemed suitable, the action resolution engine 318 may initiate corrective actions, which might include configuration changes, resource reallocation, or service restarts. For more complex or high-risk situations, the action resolution engine 318 may prepare detailed recommendations for human operators while escalating the issue through appropriate channels.

An adaptive learning module 322 may serve as a feedback mechanism within the system, continuously refining and enhancing its predictive capabilities. The adaptive learning module 322 may analyze the outcomes of both automated resolutions and human interventions, extracting valuable insights that may be used to improve the system's performance over time and providing feedback 320. The adaptive learning module 322 may employ sophisticated machine learning algorithms to identify patterns in successful resolutions and may use this information to update the knowledge base of the action resolution engine 318. The adaptive learning module may also feed back into the GenAI agent(s) 310 and time-series ML model(s) 314, 326, potentially enhancing their ability to recognize and predict fault patterns. By maintaining a constant learning loop, the adaptive learning module 322 may enable the system to adapt to evolving network conditions, new technologies, and emerging fault types. The adaptive learning module 322 may play a role in reducing false positives and improving the accuracy of fault predictions, which may lead to more efficient resource allocation and higher overall network reliability. Additionally, the adaptive learning module 322 may contribute to the system's ability to handle increasingly complex network scenarios by continuously expanding its understanding of network behavior and fault dynamics.

The training of the time-series ML model(s) 314, 326 may involve a multi-stage process that leverages both historical and real-time or near real-time network data. Initially, the time-series ML model(s) 314, 326 may be trained on a comprehensive dataset of past network events, including both normal operational patterns and known fault scenarios. This historical training data may be carefully curated to ensure it represents a wide range of network conditions and potential issues. The time-series ML model(s) 314, 326 may employ supervised learning techniques, where labeled examples of network faults and their precursors are used to teach the system to recognize similar patterns in future data streams. The adaptive learning module 322 may provide model retraining data 324 to the time-series ML model(s) 314, 326. Additionally, unsupervised learning methods may be applied to identify hidden patterns or anomalies that human analysts might overlook.

As the system operates, the time-series ML model(s) 314, 326 may continuously refine their predictive capabilities through online learning. This ongoing training process may allow the time-series ML model(s) 314, 326 to adapt to evolving network conditions and new types of faults that may emerge over time. The time-series ML model(s) 314, 326 may incorporate feedback 320 from the action resolution engine 318 and/or the adaptive learning module 322, using the outcomes of predicted faults and their resolutions to adjust their internal parameters and decision boundaries. This adaptive approach may help to improve the accuracy of fault predictions and reduce false positives over time.

The training process may also involve techniques specifically designed for time-series data, such as sliding window approaches and sequence-to-sequence learning. These methods may enable the time-series ML model(s) 314, 326 to capture complex temporal dependencies and long-term trends in network behavior. The time-series ML model(s) 314, 326 may be trained to recognize not only immediate precursors to faults but also subtle, long-term shifts in network performance that may indicate developing issues.

To enhance generalization and robustness, the training process may incorporate various data augmentation techniques. These may include generating synthetic fault scenarios, introducing controlled noise to the training data, and simulating different network topologies and configurations. This augmented training approach may help the time-series ML model(s) 314, 326 to perform well across a diverse range of network environments and fault conditions.

The training of the time-series ML model(s) 314, 326 may also involve regular validation and testing phases. Cross-validation techniques may be employed to ensure that the time-series ML model(s) 314, 326 perform consistently across different subsets of the data. Additionally, the time-series ML model(s) 314, 326 may be periodically evaluated on held-out test sets that simulate real-world scenarios, helping to assess their performance on unseen data and identify areas for improvement.

A GenAI and ML operations console 328 may serve as a centralized interface for managing and monitoring the AI and ML components of the fault detection and resolution system. The GenAI and ML operations console may provide network administrators and/or data scientists with comprehensive visibility into the operations of the GenAI agent(s) and time-series ML model(s). The GenAI and ML operations console may offer real-time or near real-time insights into the performance metrics of these AI/ML components 328, including accuracy rates, processing times, and resource utilization. The GenAI and ML operations console 328 may allow operators to fine-tune model parameters, adjust thresholds for fault prediction, and initiate retraining processes when useful. The GenAI and ML operations console 328 may also provide tools for visualizing the decision-making processes of the GenAI agent(s) 310, potentially offering explainable AI features that may help human operators understand and trust the system's recommendations. The GenAI and ML operations console 328 may include dashboards for tracking the evolution of model performance over time, which may assist in identifying trends or degradations that require attention. Additionally, the GenAI and ML operations console 328 may offer capabilities for version control and rollback of AI/ML models, ensuring that the system can maintain expected performance even as it evolves. The GenAI and ML operations console 328 may integrate with the broader network management infrastructure, potentially allowing for seamless coordination between AI-driven insights and traditional network operations tools.

A management console 334 may represent an interface between the automated fault detection system and human operators. This comprehensive user interface may provide network administrators with visibility into the system's operations, predictions, and actions. The management console 334 may display real-time or near real-time network status information, highlighting areas of concern and potential issues identified by the predictive models. The management console 334 may present detailed visualizations of network performance metrics, making complex data patterns more accessible and interpretable for human operators. When the action resolution engine 318 escalates a potential fault that requires human intervention, the management console 334 may prominently display the potential fault along with contextual information and recommended actions. This may enable operators to quickly understand the situation and make informed decisions about how to proceed.

The management console 334 may maintain a relationship with the action resolution engine 318, facilitating effective collaboration between automated systems and human operators. When the action resolution engine 318 escalates a potential fault, comprehensive diagnostic information may be transmitted to the management console 334, including the nature of the predicted issue, confidence levels, potential impacts, and recommended resolution strategies. Human operators can review this information through an intuitive interface of the management console 334 and decide whether to approve the recommended actions, modify them, or implement alternative solutions. The management console 334 may allow operators to provide feedback on the system's predictions and recommendations, which is then relayed back to the action resolution engine 318. This feedback loop enables the action resolution engine 318 to refine its decision-making processes based on human expertise and judgment, creating a synergistic relationship that leverages the strengths of both automated analysis and human insight.

The system flow ultimately reaches an end node 336, which represents the culmination of the fault detection and resolution process. This terminal point may capture the outcomes of all system activities, including successful automatic resolutions, operator-assisted interventions, and cases where no action was deemed necessary, during operation and store the activities as historical data, including any fault datasets. After the end node 336, the process may start over at the start node 300.

The layout demonstrated in FIG. 3 may suggest a comprehensive data processing and analysis workflow. In this workflow, data may move through various processing stages, with feedback loops and interconnections enabling communication between different system components. This arrangement may allow for iterative refinement of fault predictions and continuous adaptation to changing network conditions.

The system diagram in FIG. 3 may illustrate a multi-layered approach to data processing and analysis. Each layer may perform specific functions, building upon the outputs of previous layers to generate increasingly refined and actionable insights about network behavior and potential faults.

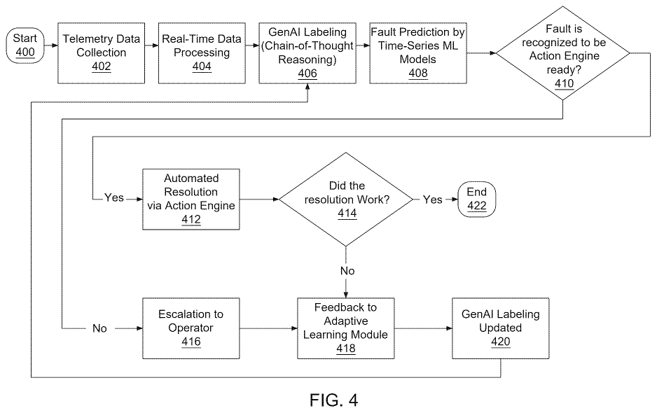

FIG. 4 depicts a flowchart for an advanced predictive fault detection and autonomous resolution system, outlining steps from data collection to fault resolution. Methods represented by the flowchart may begin with a start step 400.

After the start step 400, methods may proceed to telemetry data collection 402. In this step, the system may gather real-time or near real-time data from various network devices across the service provider's infrastructure. This telemetry data may include performance metrics, error logs, configuration information, and other relevant network statistics.

Following telemetry data collection 402, the methods may proceed to real-time or near real-time data processing 404. During this phase, the collected telemetry data may be cleaned, normalized, and aggregated. The real-time or near real-time data processing 404 may involve tasks such as time series alignment, feature extraction, and data transformation to prepare the telemetry data for further analysis.

The next step in the methods may involve GenAI labeling 406 using chain-of-thought reasoning. In this stage, artificial intelligence agents may analyze the processed telemetry data along with historical fault information. These agents may employ chain-of-thought reasoning techniques to classify and label network events, potentially improving the contextual understanding of the data.

After the GenAI labeling 406, the methods may proceed to a step for fault prediction using time-series machine learning models 408. These models may analyze the labeled network events to identify temporal patterns in network behavior. By examining these patterns, the models may predict potential faults before they impact network performance.

The methods may then reach a decision point 410 to determine if a fault is recognized to be action engine ready. This decision point 410 may involve evaluating whether the system has sufficient confidence in its fault prediction to initiate an automated response.

If the system has insufficient confidence in its fault prediction, then the methods may branch to a step to escalate to an operator 416. This escalation may involve notifying human operators and providing them with relevant information about the predicted fault and the attempted resolution. After escalation to the operator 416, the methods may move to a feedback step via the adaptive learning module 418.

If the action engine is ready, the flow may proceed to automated resolution via the action engine 412. In this step, the system may attempt to resolve the predicted fault automatically, potentially by applying predefined resolution strategies or adjusting network configurations.

Following the automated resolution 412 attempt, the methods include another decision point 414 regarding resolution status. This decision point 414 may evaluate whether the automated resolution was successful in addressing the predicted fault.

If the automated resolution was determined to be successful, then the process may end 422. The successful resolution may be recorded as historical data and later be used to train, retrain, fine-tune, etc. model(s) or engine(s).

In cases where resolution is not achieved or requires additional processing, the methods may branch to the feedback via the adaptive learning module 418 step. This feedback loop may allow the system to learn from both successful and unsuccessful resolution attempts, potentially improving its fault detection and resolution capabilities over time.

The adaptive learning module may cause the GENAI Labeling to be updated 420 and adjusted for future GenAI Labeling chain-of-thought reasoning 406. The adaptive learning module may connect back to the GenAI labeling content, creating a continuous learning cycle.

This connection may enable the system to refine its labeling and classification processes based on the outcomes of previous fault predictions and resolutions.

The methods demonstrated in FIG. 4 may illustrate a systematic approach to fault detection and resolution, incorporating both automated processing and human intervention. The design of this process may allow for continuous improvement through the feedback loop, enabling the system to learn from past experiences and enhance its predictive capabilities over time.

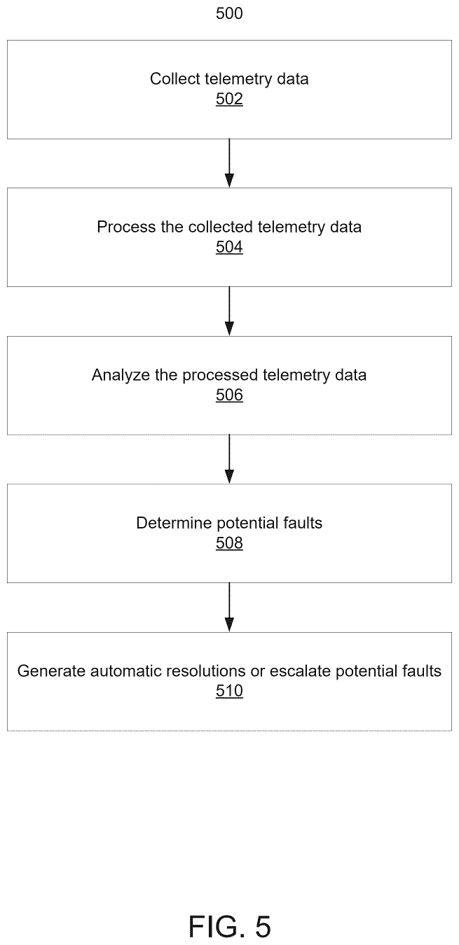

FIG. 5 depicts a flowchart of methods 500 for identifying and addressing potential network issues.

Telemetry data may be collected (block 502). The telemetry data may be real-time or near real-time. The telemetry data may be collected from a plurality of network devices. This telemetry data may include various performance metrics, error logs, and configuration information from the network devices.

The collected telemetry data may be processed (block 504). Processing the collected telemetry data may comprise data cleaning, normalization, aggregation, time series alignment, feature extraction, data transformation, etc. to prepare the telemetry data for further analysis.

The processed telemetry data may be analyzed (block 506). The processed telemetry data may be analyzed using a GenAI agent configured to apply chain-of-thought reasoning to label network events. Analyzing the processed telemetry data may comprise examining case histories and ticket logs to classify and label the network events. The GenAI agent may be configured to refine contextual understanding of the network events over time using chain-of-thought reasoning.

The GenAI agent 150 may utilize the reasoning and labeling engine 153 to apply this analysis technique, potentially improving the contextual understanding of the network events over time. The GenAI agent 150 may examine case histories and ticket logs stored in the historical database 140 to classify and label the network events. This examination may be facilitated by the historical database interface 152, allowing the GenAI agent 150 to access relevant historical information for more accurate event classification.

Potential faults may be determined (block 508). Potential faults may be determined using a time-series machine learning model configured to identify temporal patterns in the labeled network events. The one or more time-series ML model(s) 160 may perform this step by identifying temporal patterns in the labeled network events provided by the GenAI agent 150. By analyzing these patterns, the one or more time-series ML model(s) 160 may predict potential faults before they impact network performance.

Automatic resolutions may be generated or potent faults may be escalated (block 510). The automatic resolutions may be generated for the determined potential faults. The potential faults may be escalated with recommended actions. The generating the automatic resolutions for the determined potential faults may comprise resolving the faults when predefined conditions are met. These conditions may be based on factors such as the severity of the fault, the confidence level of the prediction, or the availability of pre-approved resolution strategies. Network statuses, predicted faults, the recommended actions, etc. may be displayed to a human operator when a fault is escalated. This information may be presented through the management console 190, providing network administrators with details to help address complex or unusual network issues.

The time-series machine learning model may be updated based on feedback derived from resolved faults. This feedback loop may allow the one or more time-series ML model(s) 160 to refine associated predictive capabilities over time, potentially improving the accuracy of fault detection. The reasoning and labeling capabilities of the GenAI agent may be enhanced based on outcomes of the resolved faults. This enhancement may be facilitated through the adaptive learning module interface 155, allowing the GenAI agent 150 to continuously improve its ability to classify and contextualize network events.

By implementing this method 500, the system 100 may provide a comprehensive approach to fault detection and resolution in network systems. The method 500 may leverage advanced technologies such as machine learning and artificial intelligence to predict and address network issues proactively, potentially improving overall network performance and reliability.

Although example blocks are shown, some implementations may include additional blocks, fewer blocks, different blocks, or differently arranged blocks than those depicted. Additionally, or alternatively, two or more of the blocks may be performed in parallel.

### EXAMPLES

Example Clause 1: A system for predictive fault detection and resolution in a service provider network, comprising: a telemetry collection module configured to collect real-time or near real-time telemetry data from network devices; a data processing engine configured to process the collected telemetry data; a historical fault dataset configured to store previously recorded faults and associated network event logs; a GenAI agent configured to analyze network events using chain-of-thought reasoning and to assign labels to the network events based on the processed telemetry data and the historical fault dataset; a time-series machine learning model configured to determine potential faults based on temporal patterns in network behavior identified from the labeled network events; and an action resolution engine configured to generate automatic resolutions for the determined potential faults or to escalate the potential faults with recommended actions.

Example Clause 2: The system of Example Clause 1, further comprising an adaptive learning module configured to update the time-series machine learning model based on feedback from the resolutions generated by the action resolution engine.

Example Clause 3: The system of Example Clause 1 or Example Clause 2, wherein the adaptive learning module is further configured to enhance the reasoning and labeling capabilities of the GenAI agent based on outcomes of resolved faults.

Example Clause 4: The system of any one of Example Clauses 1-3, wherein the GenAI agent is further configured to determine classifications and labels for the network events by examining case histories and ticket logs.

Example Clause 5: The system of any one of Example Clauses 1-4, wherein the GenAI agent is further configured to refine contextual understanding of the network events over time using chain-of-thought reasoning.

Example Clause 6: The system of any one of Example Clauses 1-5, wherein the action resolution engine is further configured to automatically resolve the determined potential faults when predefined resolution conditions are met.

Example Clause 7: The system of any one of Example Clauses 1-6, further comprising a management console configured to display network status information, predicted faults, and the recommended actions to a human operator when the action resolution engine escalates one of the potential faults.

Example Clause 8: A method for predictive fault detection and resolution in a service provider network, comprising: collecting real-time or near real-time telemetry data from a plurality of network devices; processing the collected telemetry data; analyzing the processed telemetry data using a GenAI agent configured to apply chain-of-thought reasoning to label network events; determining potential faults using a time-series machine learning model configured to identify temporal patterns in the labeled network events; and generating automatic resolutions for the determined potential faults or escalating the potential faults with recommended actions.

Example Clause 9: The method of Example Clause 8, further comprising updating the time-series machine learning model based on feedback derived from resolved faults.

Example Clause 10: The method of Example Clause 8 or Example Clause 9, further comprising enhancing the reasoning and labeling capabilities of the GenAI agent based on outcomes of the resolved faults.

Example Clause 11: The method of any one of Example Clauses 8-10, wherein analyzing the processed telemetry data further comprises examining case histories and ticket logs to classify and label the network events.

Example Clause 12: The method of any one of Example Clauses 8-11, wherein the GenAI agent is configured to refine contextual understanding of the network events over time using chain-of-thought reasoning.

Example Clause 13: The method of any one of Example Clauses 8-12, wherein the generating the automatic resolutions for the determined potential faults comprises resolving the faults when predefined conditions are met.

Example Clause 14: The method of any one of Example Clauses 8-13, further comprising displaying network statuses, predicted faults, and the recommended actions to a human operator when a fault is escalated.

Example Clause 15: A non-transitory computer-readable medium storing instructions that, when executed by a processor, cause the processor to perform operations for predictive fault detection and resolution in a service provider network, the operations comprising: receiving real-time or near real-time telemetry data from network devices; processing the received telemetry data; analyzing the processed telemetry data using a GenAI agent configured to apply chain-of-thought reasoning to label network events; determining potential faults using a time-series machine learning model configured to identify temporal patterns in the labeled network events; and initiating automatic resolutions for the determined potential faults or escalating the potential faults with recommended actions.

Example Clause 16: The non-transitory computer-readable medium of Example Clause 15, wherein the operations further comprise updating the time-series machine learning model based on feedback from resolved faults.

Example Clause 17: The non-transitory computer-readable medium of Example Clause 15 or Example Clause 16, wherein the operations further comprise enhancing the reasoning and labeling capabilities of the GenAI agent based on outcomes of the resolved faults.

Example Clause 18: The non-transitory computer-readable medium of any one of Example Clauses 15-17, wherein analyzing the processed telemetry data further comprises examining case histories and ticket logs to classify and label the network events.

Example Clause 19: The non-transitory computer-readable medium of any one of Example Clauses 15-18, wherein the GenAI agent is further configured to refine contextual understanding of the network events over time using chain-of-thought reasoning.

Example Clause 20: The non-transitory computer-readable medium of any one of Example Clauses 15-19, wherein the initiating the automatic resolutions for the determined potential faults comprises resolving the faults when predefined conditions are met, and wherein the operations further comprise displaying network statuses, predicted faults, and the recommended actions to a human operator when a fault is escalated.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

A number of implementations have been described. Nevertheless, it will be understood that various modifications may be made without departing from the spirit and scope of the disclosure. Accordingly, other implementations are within the scope of the following claims.

1.-20. (cancelled)

21. A method comprising:
receiving, from a plurality of network devices, telemetry data;
determining, based on the telemetry data and using a generative artificial intelligence (GenAI) agent, one or more network events;
determining, based on the one or more network events and a time-series model, one or more potential faults, wherein the time-series model is configured to identify temporal patterns in the one or more network events; and
causing, based on the one or more potential faults, one or more automated remediation actions to be initiated; and
determining, based on feedback representing outcomes of the one or more automated remediation actions, an impact-reduction score indicative of the remediation impact of the one or more automated remediation actions.

22. The method of claim 21, further comprising: updating, based on feedback representing outcomes of the one or more automated remediation actions, parameters of the time-series model.

23. The method of claim 21, wherein the causing one or more automated remediation actions to be initiated comprises automatically implementing, without human intervention, the one or more automated remediation actions.

24. The method of claim 21, wherein the generating the one or more automated remediation actions comprises outputting, to a display, the one or more potential faults and associated one or more automated remediation actions.

25. The method of claim 21, wherein the telemetry data comprises network performance metrics including latency, bandwidth utilization, packet loss, and error rate.

26. The method of claim 21, wherein the GenAI agent applies chain-of-thought reasoning to label the telemetry data into correlated network events.

27. The method of claim 21, further comprising determining a confidence score associated with each of the one or more potential faults, and selectively implementing an automated remediation actions only when the confidence score exceeds a predefined threshold.

28. A method comprising:
receiving, from a plurality of network devices, telemetry data indicative of network performance;
determining, using a correlation engine and a generative artificial intelligence (GenAI) model, one or more anomalous events within the telemetry data;
generating, using a time-series model, one or more fault probabilities associated with the anomalous events;
initiating, based on the one or more fault probabilities, one or more automated remediation actions; and
updating, based on feedback representing outcomes of the one or more automated remediation actions, parameters of the correlation engine and the time-series model.

29. The method of claim 28, wherein receiving the telemetry data comprises collecting real-time streaming data using at least one of Simple Network Management Protocol (SNMP), NETCONF, or gRPC.

30. The method of claim 28, wherein the correlation engine classifies the anomalous events according to severity levels selected from minor, major, and critical.

31. The method of claim 28, further comprising generating retraining data based on the feedback and periodically retraining the GenAI model using the retraining data.

32. The method of claim 28, wherein updating the correlation engine comprises adjusting one or more weights assigned to feature correlations among latency, bandwidth, and packet-loss patterns.

33. The method of claim 28, further comprising outputting, to a management interface, performance visualizations showing improvement metrics derived from the correlation engine or the time-series model with the updated parameters.

34. The method of claim 28, wherein the feedback comprises one or more operator confirmations or automated verification results confirming successful remediation of a detected fault.

35. A method comprising:
receiving, from one or more network devices, telemetry data;
determining, using a generative artificial intelligence (GenAI) fault-analysis agent, one or more anomalies in the telemetry data;
determining, using a contextual correlation model, one or more root-cause hypotheses for the one or more anomalies;
outputting, to a user interface, the one or more root-cause hypotheses with corresponding confidence values; and
receiving operator feedback indicating confirmation or rejection of one of the root-cause hypotheses.

36. The method of claim 35, wherein the GenAI fault-analysis agent applies multi-step reasoning to correlate anomalies across different network domains including access, transport, and core layers.

37. The method of claim 35, wherein determining the one or more root-cause hypotheses comprises retrieving historical incident data from a network-operations knowledge base.

38. The method of claim 35, wherein the operator feedback is used to refine weights of the contextual correlation model through supervised fine-tuning.

39. The method of claim 35, further comprising, when the operator feedback indicates confirmation of one of the root-cause hypotheses resulting in a confirmed root-cause hypothesis, generating, based on the confirmed root-cause hypothesis, one or more recommended remediation actions and displaying the recommended remediation actions in the user interface.

40. The method of claim 35, wherein receiving the telemetry data comprises continuously monitoring network logs, performance counters, and alarm data streams.
